(19) United States
(12) Patent Application Publication
(10) Pub. No.: US 2018/0314274 A1
(43) Pub. Date: Nov. 1, 2018

(54) GAS PROCESSING AND MANAGEMENT SYSTEM FOR SWITCHING BETWEEN OPERATING MODES

(71) Applicant: Atlas Copco Comptec, LLC, Voorheesville, NY (US)

(72) Inventor: Todd Steven Abbot Gibbs, Amsterdam, NY (US)

(21) Appl. No.: 15/961,099

(22) Filed: Apr. 24, 2018

Related U.S. Application Data
(60) Provisional application No. 62/491,729, filed on Apr. 28, 2017.

(51) Int. Cl. G05D 16/20; F04D 27/00; F04B 49/22; F04C 28/24

(52) U.S. Cl. CPC G05D 16/2026; F04C 28/24; F04B 49/22; F04D 27/005

(57) ABSTRACT

A gas process compressor having a first compressor section and a second compressor section, wherein a first operating mode for a gas processing system is switched to a second operating mode by opening and closing one or more valves controlling a flow of the natural gas stream to the first compressor section and the second compressor section. A gas processing and management system and method for switching between operating modes e is also provided.

### CROSS-REFERENCE TO RELATED APPLICATIONS

This application claims priority to and the benefit of U.S. Provisional Application No. 62/491,729, filed Apr. 28, 2017, and entitled “Gas Processing and Management System for Switching Between Operating Modes,” the entire contents of which are hereby incorporated by reference.

### TECHNICAL FIELD

The following relates to embodiments of a gas processing and management system for switching between operating modes.

### BACKGROUND

Natural gas streams are processed for ethane recovery and ethane rejection at different operating modes. Currently, different compressors may be required to switch between ethane recovery and ethane rejection modes. To accomplish the switch between rejection and recovery, two independent compressor are used or the existing compressor must be completely or partially disassembled, and outfitted with the equipment necessary for recovery or rejection.

Thus, there is a need for a single compressor unit that can effectively switch between recovery and rejection modes.

### SUMMARY

An aspect relates to a compressor, comprising: a first compressor section, and a second compressor section, wherein a first operating mode for a gas processing system is switched to a second operating mode by opening and closing one or more valves controlling a flow of the natural gas stream to the first compressor section and the second compressor section

An aspect relates to a gas processing and management system comprising: a multi-stage compressor, the multi stage compressor including a first compression section and a second compression section, an inlet receiving a stream of natural gas containing an ethane gas, a first conduit fluidically connected to the inlet, the first conduit extending from the inlet to the first compression section of the multi-stage compressor, a second conduit fluidically connected to the inlet, the second conduit extending from the inlet to the second compression section of the multi-stage compressor, a first valve controlling a flow of the stream of natural gas to the second compression section of the multi-stage compressor, a second valve controlling a flow of the stream of natural gas between the first conduit and the second conduit, and a third valve controlling a flow of the stream of natural gas between the first compression section and an outlet.

An aspect relates to a method for switching between a first operating mode to rejection second operating mode in a gas processing system including a multi-stage compressor, a first valve, a second valve, and a third valve, the method comprising: closing the first valve and the third valve so that a stream of natural gas flows from an inlet to a first compressor section of the multi-stage compressor and then to a second compressor section of the multi-stage compressor in series operation after compression by the first compressor section, and opening the first valve and the third valve while closing the second valve so that the stream of natural gas flows from the inlet to the first compressor section and to the second compressor section in parallel operation.

An aspect relates to a parallel/series compressor switching system and method.

An aspect relates to a gas processing and management of different operating modes.

The foregoing and other features of construction and operation will be more readily understood and fully appreciated from the following detailed disclosure, taken in conjunction with accompanying drawings.

### BRIEF DESCRIPTION OF THE DRAWINGS

Some of the embodiments will be described in detail, with reference to the following figures, wherein like designations denote like members, wherein:

FIG. 1 depicts a schematic view of a gas processing system in a first operating mode, in accordance with embodiments of the present invention;

FIG. 2 depicts a schematic view of a gas processing system in a second operating mode, in accordance with embodiments of the present invention; and

FIG. 3 depicts a perspective view of a compressor unit having multi-stages of compression for operating in a first operating mode and a second operating mode, in accordance with embodiments of the present invention.

### DETAILED DESCRIPTION

A detailed description of the hereinafter described embodiments of the disclosed apparatus, method, and system are presented herein by way of exemplification and not limitation with reference to the Figures. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

Current methods and systems for ethane recovery and ethane rejection require different modes of operation (i.e. recovery mode and rejection mode). The recovery mode currently uses a two stage compressor that receives the natural gas for compression and recovery of ethane from the natural gas stream, while the rejection mode uses a different type of compressor, such as a single stage compressor that receives the natural gas for compression and rejection or non-recovery of ethane gas. Switching between operating modes (i.e. between recovery and reject) requires either two independent compressors or significant modifications to a single existing compressor in the system. The modifications of a single compressor system are time consuming and expensive, typically requiring a service engineer to tear down the machine and change several components. Thus, a need exists for switching between operating modes by avoiding significant modifications to existing compressors.

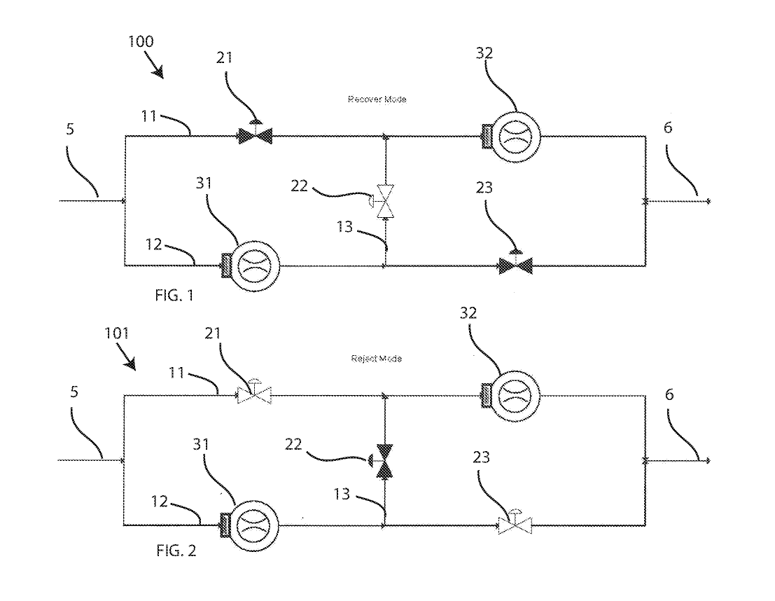

FIG. 1 depicts a system 100 for a first operating mode of gas processing system 100. In an exemplary embodiment, the first operating mode of the gas processing system 100 is an ethane recovery operating mode. Embodiments of the system 100 may include an inlet 5, which contains or otherwise receives a natural gas stream, a first line or conduit 11, a second line or conduit 12, a third line or conduit 13, a first valve 21, a second valve 22, a third valve 23, a first compressor section 31, a second compressor section 32, and an outlet 6 for continued processing/carrying of the natural gas stream for recovery of ethane from the processed stream. Embodiments of the first compressor section 31 and the second compressor section 32 may each be a single stage compressor, or may be stages of a multi-stage compressor. Each compression section may have an inlet guide vane or an inlet throttle valve, or other flow controlling device. If the process is stable enough, the second section of compression may not need an additional throttling device. Further, valves 21, 22, 23 may be manual or automated, and blind flanges may also be suitable for proper isolation. Embodiments of the valves 21, 22, 23 may be an isolation valve, such as a gate valve, butterfly valve, ball valve, globe valve, and the like, or may be a blind flange.

In the first operating mode of system 100, the first valve 21 may be in a closed position, such that the natural gas flows from the inlet 5 to the first compressor section 31 via line 12. The first compressor section 31 may compress the natural gas stream, for example, as a first stage of compression. Further, embodiments of the third valve 23 may be in a closed position, such that the compressed stream flows from first compressor section 31 via line 12 and into line 13, which may connect lines 11 and 12. For example, the third valve 22 may be positioned along line 13, and may be positioned downstream of the first compressor section 31 and upstream of the second compressor section 32. The compressed stream may flow through line 13 and then to the second compressor section 32 via a portion of line 11. The second compressor section 32 may further compress the natural gas stream, for example, as a second stage of compression. The further compressed stream may exit via outlet 6 for further processing, such as a recovery of ethane. The configuration of system 100 results in a low flow, high pressure ratio for better recovery of ethane from the stream leaving outlet 6. Furthermore, the recovery mode may be achieved without modifying the compressor sections 31, 32 of a compressor unit. Embodiments of the system 100 representing a recovery mode may include the first compressor section 31 and the second compressor section 32 in a series operation. Embodiments of lines 11, 12, 13 may be a pipe, a line, a connection, a fluidic connection, and the like.

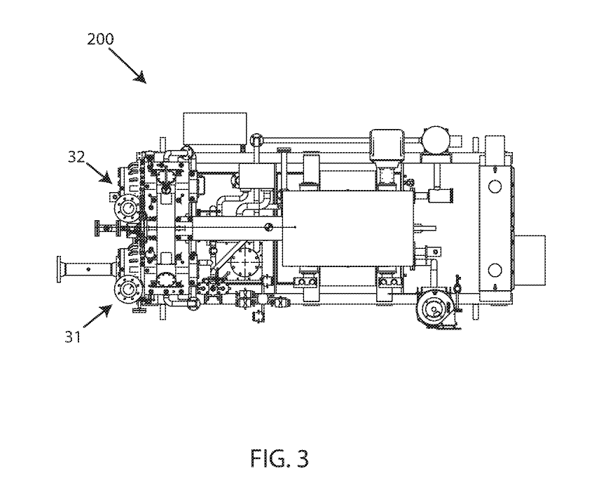

FIG. 2 depicts a gas processing system 101 for a second operating mode. In an exemplary embodiment, the second operating mode is an ethane rejection operating mode. Embodiments of the system 101 may include the same compressor or compressor unit of system 100. For instance, embodiments of the system 100 may include an inlet 5, which contains a natural gas stream, a first line or conduit 11, a second line or conduit 12, a third line or conduit 13, a first valve 21, a second valve 22, a third valve 23, a first compressor section 31, a second compressor section 32, and an outlet 6 for continued processing/carrying of the natural gas stream. Embodiments of the first compressor section 31 and the second compressor section 32 may each be a single stage compressor, or a compression stage of a multi-stage compressor. Each compression section may have an inlet guide vane or an inlet throttle valve, or other flow controlling device. If the process is stable enough, the second section of compression may not need an additional throttling device. Further, valves 21, 22, 23 may be manual or automated, and blind flanges may also be suitable for proper isolation. In the second operating mode of system 101, the first valve 21 may be in an open position, such that the natural gas stream is split or otherwise distributed to flow from the inlet 5 to the first compressor section 31 via line 12, and to the second compressor section 32. The second valve 22 may be in a closed position. The second valve 22 being in the closed position may prevent the compressed gas exiting from the first compressor section 31 to enter line 11 and into the second compression section 32. The third valve 23 may be in an open position to allow the compressed stream from the first compressor section 31 to flow to the outlet 6. The compressed stream from the second compressor section 32 via line 11 to the outlet 6. The configuration of system 101 may result in an increased volume of flow and a reduced pressure ratio, which may be ideal for ethane rejection. Furthermore, switching from the recovery operating mode to the reject operating mode may be achieved without modifying the compressor sections 31, 32 or the compressor unit. Embodiments of the system 101 representing a reject mode may include the first compressor section 31 and the second compressor section 32 in a parallel operation. FIG. 3 depicts a perspective view of a compressor unit 200 having multi-stages of compression for operating in two different operating modes, such as a recovery and a rejection mode of ethane or other gases, in accordance with embodiments of the present invention. Embodiments of the compressor unit 200 may be a compressor, a compressor unit, a multi-stage compressor, and the like, capable of compressing natural gas and performing ethane recovery and ethane rejections modes of operation. In an exemplary embodiment, the compressor 200 may be a centrifugal compressor. In other exemplary embodiments, the compressor 200 may be a dynamic compressor, such as a centrifugal compressor, an axial compressor, a positive displacement compressor, such as a reciprocating compressor, a screw compressor, and the like. Embodiments of the compressor 200 may include multi-stages of compression, including the first compression section 31 and the second compression section 32. The compression sections 31, 32, and potential additional stages of compression of the compressor 200 may be connected via piping or other flow path structure. Further, embodiments of the compression sections 31, 32 may each include one or more stages of compression, wherein the one or more stages of compression include at least one of: a dynamic compressor and a positive displacement compressor.

Accordingly, embodiments of compressor 200 may switch between operating modes (e.g. first operating mode and second operating mode) by controlling one or more valves 21, 22, 23. In an exemplary embodiment, the compressor 200 may switch between an ethane recovery mode, as shown in system 100, to an ethane rejection mode, as shown in system 101, by controlling one or more valves 21, 22, 23. Opening and closing valves 21, 22, 23 as described above is significantly less intensive than requiring an existing compressor to be disassembled for replacement of key components of the compressor. Other operating modes may be utilized using the compressor 200 consistent with systems 100, 101. For example, other gases may be rejected and recovered using the compressor 200 in view of systems 100, 101.

Referring to FIGS. 1-3, a method for switching between a first operating mode and a second operating mode (e.g. between an ethane recovery mode to an ethane rejection mode) in a gas processing system 100, 101 including a multi-stage compressor 200, a first valve 21, a second valve 22, and a third valve 23, may include the steps of closing the first valve 21 and the third valve 23 so that a stream of natural gas may flow from an inlet 5 to a first compressor section 31 of the multi-stage compressor 200 and then to a second compressor section 32 of the multi-stage compressor 200 in series operation after compression by the first compressor section 31. In some embodiments, the closing of the first valve 21 and the third valve 23 may cause ethane contained within the stream of natural gas to be recovered by the gas processing system that includes system 100. During this step, the second valve 22 may be opened. The method may also include the step of opening the first valve 21 and the third valve 23 so that the stream of natural gas may flow from the inlet 5 to the first compressor section 31 and to the second compressor section 32 in parallel operation. In some embodiments, the opening of the first valve 21 and the third valve 23 may cause ethane contained within the stream of natural gas to be rejected by the gas processing system that includes system 101. During this step, the second valve 22 may be closed. The operating of the valves 21, 22, 23, such as the opening and closing of the valves may be performed automatically by a computer system, control system, controller, etc. In an alternative embodiment, the valves 21, 22, 23 may be opened and closed manually.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the invention, as required by the following claims. The claims provide the scope of the coverage of the invention and should not be limited to the specific examples provided herein.

1. A compressor, comprising:
a first compressor section; and
a second compressor section;
wherein a first operating mode for a gas processing system is switched to a second operating mode by opening and closing one or more valves controlling a flow of the gas stream to the first compressor section and the second compressor section.

2. The compressor of claim 1, wherein the first operating mode is for recovering ethane from a gas stream, and the second operating mode is for non-recovery of ethane from the gas stream.

3. The compressor of claim 1, further comprising an inlet for receiving the gas stream.

4. The compressor of claim 1, wherein the first compressor section and the second compressor section each include one or more stages of compression.

5. The compressor of claim 4, wherein the one or more stages of compression include at least one of: a dynamic compressor and a positive displacement compressor.

6. The compressor of claim 1, wherein the first compressor section operates in series with the second compressor section in the first operating mode.

7. The compressor of claim 1, wherein the first compressor section operates in parallel with the second compressor section in the second operating mode.

8. A gas processing and management system comprising:
a multi-stage compressor, the multi stage compressor including a first compression section and a second compression section;
an inlet receiving a stream of gas containing an ethane gas;
a first conduit fluidically connected to the inlet, the first conduit extending from the inlet to the first compression section of the multi-stage compressor;
a second conduit fluidically connected to the inlet, the second conduit extending from the inlet to the second compression section of the multi-stage compressor;
a first valve controlling a flow of the stream of gas to the second compression section of the multi-stage compressor;
a second valve controlling a flow of the stream of gas between the first conduit and the second conduit; and
a third valve controlling a flow of the stream of gas between the first compression section and an outlet.

9. The gas processing and management system of claim 8, further comprising a third conduit connecting the first conduit and the second conduit.

10. The gas processing and management system of claim 9, wherein the third conduit is located downstream of the first compression section and the first valve, and upstream of the second compression section and the third valve.

11. The gas processing and management system of claim 10, wherein the second valve is positioned along the third conduit.

12. The gas processing and management system of claim 8, wherein, in an ethane recovery mode, the first valve is in a closed position, the second valve is in an open position, and the third valve is in a closed position.

13. The gas processing and management system of claim 12, wherein the stream of gas flows through the inlet to the first compression section through the first conduit, and a compressed stream of gas exits the first compression section and flow directly to the second compression section for additional compression, and then exits through the outlet.

14. The gas processing and management system of claim 12, wherein the first compression section and the second compression section operate in series in the ethane recovery mode.

15. The gas processing and management system of claim 8, wherein, in a ethane rejection mode, the first valve is in an open position, the second valve is in a closed position, and the third valve is in an open position.

16. The gas processing and management system of claim 15, wherein the stream of gas flows through the inlet both to the first compression section through the first conduit and to the second compression section through the second conduit, and a compressed stream of gas exits the first compression section and a compressed stream of natural gas exits the second compressions section and flows directly to the outlet.

17. The gas processing and management system of claim 15, wherein the first compression section and the second compression section operate in series in the ethane recovery mode.

18. The gas processing and management system of claim of 8, wherein the first valve, the second valve, and third valve are switched from open position to closed positions automatically to switch between an ethane recovery mode to an ethane rejection mode without adjusting the multi-stage compressor.

19. A method for switching between a first operating mode to a second operating mode in a gas processing system including a multi-stage compressor, a first valve, a second valve, and a third valve, the method comprising:
closing the first valve and the third valve so that a stream of gas flows from an inlet to a first compressor section of the multi-stage compressor and then to a second compressor section of the multi-stage compressor in series operation after compression by the first compressor section; and
opening the first valve and the third valve so that the stream of gas flows from the inlet to the first compressor section and to the second compressor section in parallel operation.

20. The method of claim 17, wherein the first valve is located along a first conduit fluidically connected to the inlet, the first conduit extending from the inlet to the second compressor section of the multi-stage compressor.

21. The method of claim 17, wherein the third valve is located along a second conduit downstream of the first compressor section.

22. The method of claim 17, wherein the second valve is located along a third conduit fluidically connecting the first conduit and the second conduit, the second valve being located downstream of the first compressor section and upstream of the second compressor section.

23. The method of claim 17, wherein the first operating mode is an ethane gas recovery mode and the second operating mode is an ethane rejection mode.

24. The method of claim 17, wherein closing the first valve and the third valve causes an ethane gas contained within the stream of gas to be recovered

25. The method of claim 17, wherein opening the first valve and the third valve causes an ethane gas contained within the stream of gas to be rejected.
